(19) United States
(12) Patent Application Publication
(10) Pub. No.: US 2024/0278644 A1
(43) Pub. Date: Aug. 22, 2024

(54) TRAILER CONNECTION SAFETY SYSTEM

(71) Applicant: PACCAR Inc, Bellevue, WA (US)

(72) Inventors: KYLE GILLIAM, Denton, TX (US); CLIFTON ELLIS, Weatherford, TX (US)

(73) Assignee: PACCAR Inc, Bellevue, WA (US)

(21) Appl. No.: 18/170,176

(22) Filed: Feb. 16, 2023

(51) Int. Cl. B60K 35/00; B60D 1/28; B60D 1/64; B60K 28/10

(52) U.S. Cl. CPC B60K 35/00; B60D 1/28; B60D 1/64; B60K 28/10; B60K 35/215; B60K 35/28; B60K 2360/178

(57) ABSTRACT

A trailer connection safety system is provided. In example aspects, the system receives an action by an operator of a vehicle and determines a connection state of an electrical cable. If the electrical cable is not in an appropriate state for the action of the operator, an alert is generated and displayed. In further aspects, the system may act as an interlock to prevent the action of the operator if the electrical cable is not in an appropriate state.

### BACKGROUND

Semi-trailer trucks, commonly known as semitrucks, are one of the leading ways to transport freight. Semi-trailer trucks typically include a tractor hauling one or more trailers, with the trailer connected to the tractor by means of a kingpin hooked to a coupling device on the tractor in many constructions. Trailers may also connect to tractors via an electrical cable to control lights and electrical systems of the trailer, as well as one or more air hoses to control, e.g., trailer brakes.

Throughout its lifetime, one tractor may be responsible for hauling numerous different trailers for different shipments. As such, the tractor must be continually connected and disconnected from the trailers. This can lead to operator mistakes in the connection process which result in unsafe driving conditions. For example, a tractor may be coupled to a trailer without the electrical cable being properly connected, causing the trailer lights to not be active. Additionally, air hoses may not be properly connected to the trailer, which could affect operability of the trailer's brakes. Further, mistakes in the disconnection process could lead to damage or malfunction of the equipment of the tractor and/or trailer. For example, an operator of the tractor may unhitch the tractor from a trailer without prior disconnection of the electrical cable and/or air hoses, potentially leading to equipment damage as the tractor pulls away from the trailer.

### SUMMARY

In general, the present disclosure relates to a trailer connection safety system. In example embodiments, the system uses a connection state of an electrical cable in generating alerts.

In a first aspect, a method is provided. A vehicle's electronic control unit, which is connected to a vehicle control subsystem, receives a signal indicating an action by an operator of the vehicle. A connection state of an electrical cable is also determined. The electrical cable has a first end that is electrically connected to the vehicle control subsystem and a second end that is removably connectable to an electrical socket of a trailer. When the second end of the cable is connected to the electrical socket of the trailer, an electrical connection is formed between the vehicle control subsystem and the trailer. The action of the operator and the connection state of the electrical cable are used to determine whether the connection state of the electrical cable is an appropriate state for the action by the operator. Based on a determination that the connection state of the electrical cable is not an appropriate state for the action by the operator, an alert is generated. This alert indicates that the electrical cable is not in an appropriate state for the action by the operator, and it is presented at an operator interface.

In a second aspect, a method is provided. A vehicle's electronic control unit, which is connected to a vehicle control subsystem, receives a signal indicating an action by an operator of the vehicle. The action by the operator indicates intended operation of the vehicle. A connection state of an electrical cable is also determined. The electrical cable has a first end electrically connected to the vehicle control subsystem and a second end that is removably connectable to an electrical socket of a trailer. When the second end of the cable is connected to the electrical socket of the trailer, an electrical connection is formed between the vehicle control subsystem and the trailer. Determining the connection state of the electrical cable includes detecting whether the second end of the cable is stowed at a storage socket on the tractor and detecting whether the second end of the cable is connected to the electrical socket of the trailer. The action of the operator and the connection state of the electrical cable are used to determine whether the connection state of the electrical cable is an appropriate state for the action by the operator. Based on a determination that the connection state of the electrical cable is not an appropriate state for the action by the operator, an alert is generated. This alert indicates that the electrical cable is not in an appropriate state for the action by the operator, and it is presented at an operator interface.

In a third aspect, a vehicle is provided. The vehicle has an electronic control unit, which is communicatively connected to a vehicle control subsystem. The electronic control unit receives a signal indicating an action by an operator of the vehicle. The electronic control unit also determines a connection state of an electrical cable. The electrical cable has a first end electrically connected to the vehicle control subsystem and a second end that is removably connectable to an electrical socket of a trailer. When the second end of the cable is connected to the electrical socket of the trailer, an electrical connection is formed between the vehicle control subsystem and the trailer. Using the action of the operator and the connection state of the electrical cable, the electronic control unit determines whether the connection state of the electrical cable is an appropriate state for the action by the operator. If the electrical control unit determines that the connection state of the electrical control unit is not an appropriate state for the action by the operator, the electrical control unit generates an alert. This alert indicates that the electrical cable is not in an appropriate state for the action by the operator. The electronic control unit presents this alert at an operator interface

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a side view of a vehicle in which aspects of the present disclosure can be implemented.

FIG. 2 illustrates a rear view of an embodiment of tractor with a storage socket.

FIG. 3 illustrates a front view of an embodiment of a connector storage unit with a storage socket.

FIG. 4 illustrates an embodiment of a circuit of a storage socket.

FIG. 5 illustrates a block diagram of an embodiment of a trailer connection safety system.

FIG. 6 illustrates an embodiment of an operator interface with a safety alert presented.

FIG. 7 illustrates a flowchart of a method for improving safety in a vehicle.

FIG. 8 illustrates a flowchart of a method for generating alerts when an operator puts a vehicle into drive.

FIG. 9 illustrates a flowchart of a method for generating alerts when an operator supplies air to a trailer.

FIG. 10 illustrates a flowchart of a method for generating alerts when an operator decouples a tractor from a trailer.

FIG. 11 illustrates a flowchart of a method for assisting in decoupling a tractor from a trailer based on a connection state of an electrical cable.

FIG. 12 illustrates a block diagram of an example physical components of a computing device or system with which embodiments may be practiced.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used herein, the term “including” as used herein should be read to mean “including, without limitation,” “including but not limited to,” or the like. The term “substantially” as used herein is a broad term and is to be given its ordinary and customary meaning to a person of ordinary skill in the art (and is not to be limited to a special or customized meaning), and furthermore refers without limitation to being largely but not necessarily wholly that which is specified.

As briefly described above, embodiments of the present disclosure are directed to a system and method for providing safety alerts to a vehicle operator. Such safety alerts may be, for example, based on the connection status of an electrical cable, and optionally the operational status of air hoses, of a vehicle such as a semi-trailer truck. In example aspects, a system monitors the connection status of an electrical cable used for connection between a tractor and a trailer to determine if an action by an operator of the semi-trailer truck is appropriate. For example, the system may determine whether the electrical cable is attached to a trailer. If the electrical cable is not attached to a trailer and the operator takes actions indicative of a trailer being connected to the tractor, such as supplying trailer air or otherwise initiating vehicle operation, the system may generate a safety alert. In additional aspects, the system may act as an interlock to prevent inappropriate actions from being taken based on sensed conditions of the electrical cable and/or air hoses.

By monitoring the connection status of the electrical cable and/or air hoses between a tractor and trailer, safety can be improved in the operation of semi-trailer trucks. For example, instances in which a semi-trailer truck is operated without trailer lights can be reduced. Additionally, semi-trailer truck equipment-such as the electrical cable—can be better protected. For example, the system can verify that the electrical cable is properly disconnected from the trailer and properly stowed before the trailer is decoupled from the tractor, preventing damage to the electrical cable caused by driving the tractor away from the decoupled trailer while the electrical cable is either still attached or unstowed (e.g., dragged loose behind the tractor).

In example implementations, aspects of the system, including detection circuitry and logical operations, may be performed using an electronic control unit (ECU) of the tractor. Such detection circuitry may receive signals from, for example, the electrical cable and/or pneumatic subsystem, as well as other circuits and/or sensors within the vehicle that may indicate an intent to operate the vehicle.

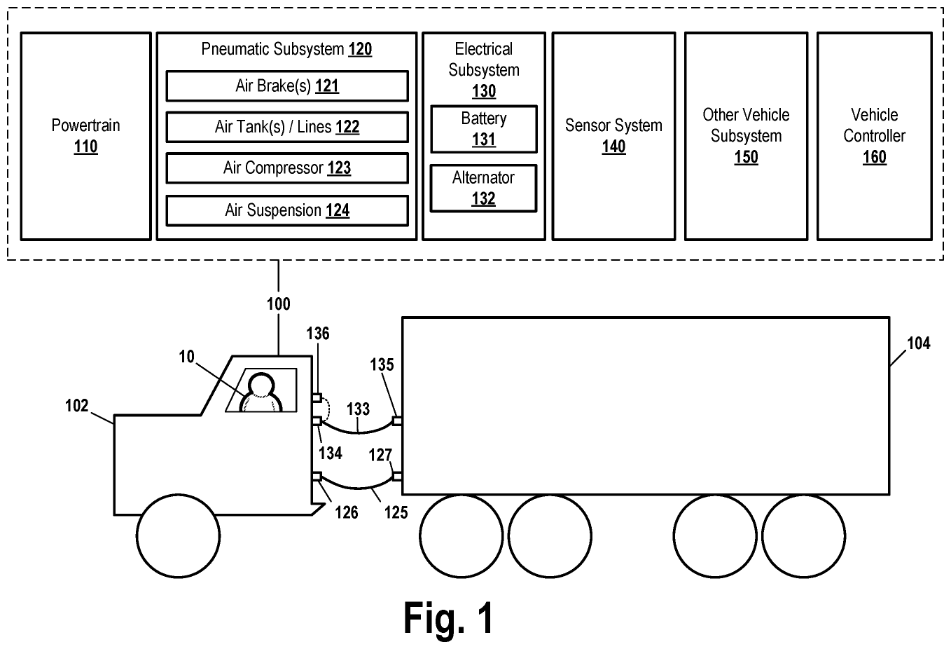

Referring now to FIG. 1, an example embodiment of a vehicle 100 in which aspects of the present disclosure may be implemented is shown. The vehicle 100 is one example of a type of vehicle that may be used in accordance with the trailer connection safety system described herein. In the illustrated embodiment, the vehicle 100 is a semi-trailer truck, with a tractor 102 removably couplable with a trailer 104. For ease of illustration, a gap is shown between the tractor 102 and the trailer 104; however, when the tractor 102 is coupled to the trailer 104, there may not be such a gap. In example embodiments, the tractor 102 may be coupled to the trailer 104 by a coupling device known as a fifth wheel.

The vehicle 100 may be operated by an operator 10. The vehicle may have one or more vehicle control subsystems. In the example shown, the vehicle 100 includes a powertrain 110, a pneumatic subsystem 120, an electrical subsystem 130, a sensor system 140, one or more other vehicle subsystems 150, and a vehicle controller 160.

The powertrain 110 operates to generate power and convert the power into movement of the vehicle 100. In an embodiment, the powertrain 110 includes an engine, which may be powered by fuel such as gasoline or diesel. In alternative embodiments, the powertrain 110 may include an electric motor. In further embodiments, other types of systems for converting other forms of energy into mechanical energy may be used. The powertrain 110 may also include other components to convert the engine's power into movement, such as a transmission, driveshafts, differential, and axles.

In the example shown, the pneumatic system 120 may include air brakes 121, one or more air tanks 122, and lines there between, an air compressor 123, and an air suspension 124. When the operator 10 presses on a brake pedal, air is released from the air tanks 122 to actuate the air brakes 121. Both the tractor 102 and the trailer 104 may have air brakes 121. In an embodiment, the air tanks 122 are located in the tractor 102, and an air hose 125 supplies air to the air brakes 121 of the trailer 104. The air hose 125 may be connected at an air output 126 on the tractor 102 and an air input 127 on the trailer 104. In some embodiments, multiple air hoses 125 may be used to supply air to the trailer 104. For example, one air hose 125 may be used for emergency brakes in the trailer 104 and a second air hose 125 may be used for a service brake in the trailer 104. The air hose 125 may be removable from the trailer 104 for when the tractor 102 is operated decoupled from the trailer 104. When not attached to the trailer 104, the air hose 125 may be stored in a dummy coupler on the tractor 125.

On an as needed basis, the air compressor 123 may be operated to repressurize the air tanks 122 and lines connecting the air tanks 122 with the other pneumatic subsystem 120 components. The air compressor 123 may be powered, for example, via the electrical subsystem 130.

The air suspension 124 may utilize airbags on axles of the vehicle 100 to stabilize the vehicle 100 as it drives by absorbing bumps and vibrations with the airbags. These airbags may receive pressurized air from the air tanks 122. The air suspension 124 may also be used to raise and lower the tractor 102 as it couples with and decouples from the trailer 104.

In an embodiment, the operator 10 may control aspects of the pneumatic system 120 through one or more valves within the tractor 102. In alternative embodiments, the tractor 102 may include one or more electronic switches and a computerized system to control aspects of the pneumatic system 120.

The electrical subsystem 130 may include one or more batteries 131 and an alternator 132 to power the other systems and subsystems within the vehicle 100. The battery 131 may provide power to these systems when the engine of the vehicle 100 is off, and the alternator 132 may provide power when the engine is running. In alternative embodiments (e.g., in which the powertrain 110 uses an electric motor), the alternator 132 may be excluded, and the one or more batteries 131 may include one or both of low-voltage and high-voltage batteries.

In an embodiment, the electrical subsystem 130, including optionally the battery 131 and alternator 132, is located within the tractor 102, and an electrical cable 133 is used to supply electricity from the tractor 102 to the trailer 104. The trailer 104 may use this electricity, for example, to power lights, including running lights and/or brake lights on the trailer. The tractor 102 may include an electrical socket 134 to which one end of the cable 133 is connected. Electricity from the electrical subsystem 130 may flow through the cable 133 to a second end that is plugged into an electrical socket 135 on the trailer 104. The tractor 102 may also include a storage socket 136, which can be used to store the second end of the electrical cable 133 when it is not connected to the electrical socket 135 on the trailer 104. The storage socket 136 helps to protect the electrical cable 133 by preventing it from swinging around loose when the tractor 102 is in operation and the trailer 104 is not coupled. As described below, the storage socket 136 may be integrated in a connector storage unit.

The sensor system 140 may provide information about the vehicle 100 to the vehicle controller 160. Examples of sensors in the sensor system 140 include a fluid temperature sensor, an engine speed sensor, a vehicle speed sensor, a battery sensor, a brake sensor, a vehicle weight sensor, a vehicle height sensor, and a global positioning system sensor. Different embodiments may include a subset of the sensors given as examples and may include additional sensors.

The vehicle 100 may include one or more other vehicle subsystems 150, such as accessory power systems, vehicle cabin temperature conditioning systems, communication systems, and various other types of equipment. These other vehicle subsystems 150 may be powered via the electrical subsystem 130.

The vehicle controller 160 includes a programmable circuit, such as a computing device, which may be operable to control one or more subsystems of the vehicle 100. For example, the vehicle controller 160 may receive signals from the sensor system 140 or from the pneumatic subsystem 120, electrical subsystem 130, powertrain 110 or other vehicle subsystems 150, and may provide control signals, via a control bus within the vehicle 110, for actuating one or more subsystems in response to sensed conditions and/or operator 10 inputs. In some example embodiments, as described herein, the vehicle controller 160 may include instructions for generating alerts based on a connection state of the electrical cable 133. In an embodiment, the vehicle controller 160 may be an electronic control unit (ECU) configured to electrically control various vehicle operations and/or displays.

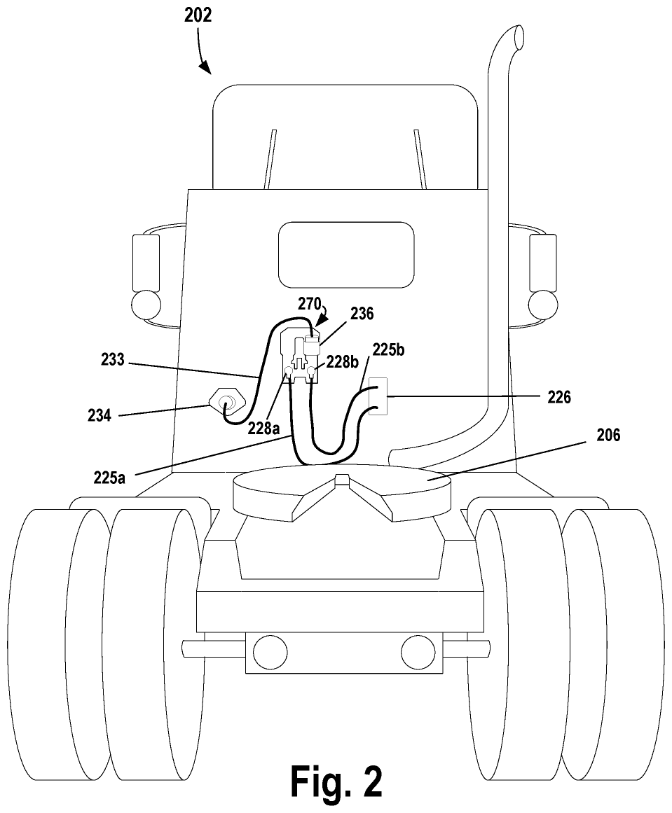

Turning to FIG. 2, a rear view of an embodiment of a tractor 202 is shown. The tractor 202 may have the same systems and subsystems as described in FIG. 1. In alternative embodiments, the tractor 202 may include additional or alternative systems and components. Additionally, in alternative embodiments, the tractor 202 may be a different type of vehicle; while FIG. 2 depicts a tractor, it should be appreciated that the present technology is applicable to any type of vehicle capable of towing a trailer.

In the illustrated embodiment, the tractor 202 is configured to tow a trailer. The tractor 202 includes a coupling device 206-a fifth wheel in the depicted embodiment—for coupling with a trailer. The tractor 202 also has an electrical cable 233 for supplying electricity to a trailer and two air hoses 225 for supplying pressurized air to a trailer. In alternative embodiments, the tractor 202 may have a different number of electrical cables 233 and/or air hoses 225.

As described above, the electrical cable 233 supplies power between an electrical socket 234 on the tractor 202 and an electrical socket on a trailer, and the air hoses 225 supply pressurize air between an air output 226 on the tractor and an air input on a trailer. When the tractor 202 is decoupled from a trailer, the electrical cable 233 may be stowed in a storage socket 236. The air hoses 225 may be stowed with dummy couplers 228a-b (collectively, dummy couplers 228) on the back of the tractor 202. In some embodiments, the storage socket 236 and the dummy couplers 228 may be part of a single connector storage unit 270.

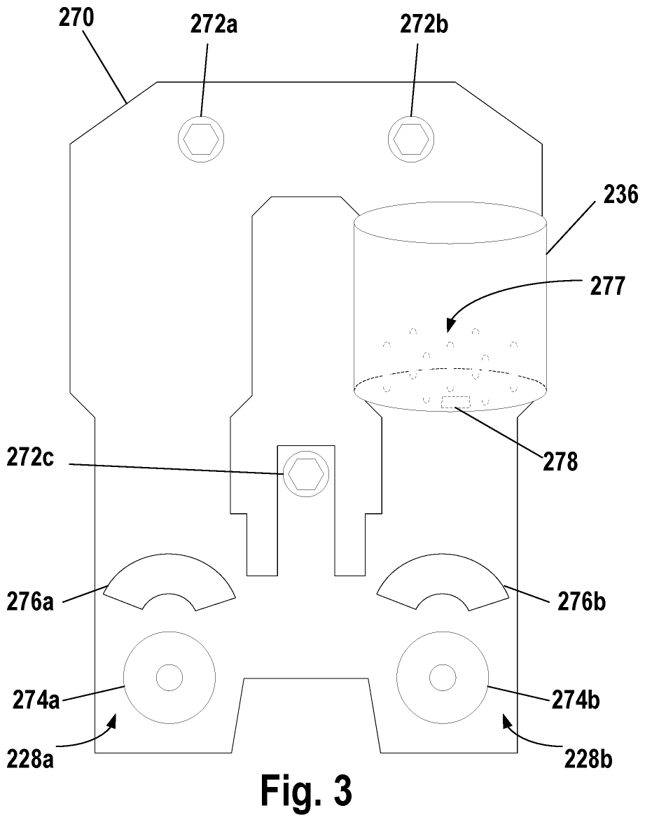

FIG. 3 depicts a front view of an embodiment of a connector storage unit 270 useable in the context of the present disclosure. The connector storage unit 270 may be attached to the back side of a tractor (e.g., at a rear side of the cab, facing toward the coupling device 206) by a plurality of fasteners 272. In an embodiment, the fasteners 272 may be bolts, and nuts may be screwed onto the bolts to affix the connector storage unit 270 to a tractor. The connector storage unit 270 may be made of metal. In alternative embodiments, the connector storage unit may be made of plastic or another sturdy, weather resistant material. In further embodiments, the connector storage unit 270 may be made of multiple materials, with different components being made of different materials.

As described above, the connector storage unit 270 may include a storage socket 236 for an electrical cable and a plurality of dummy couplers 228 for air hoses. In alternative embodiments, the connector storage unit 270 may have different numbers of storage sockets 236 and/or dummy couplers 228 to accommodate different numbers of electrical cables 233 and/or air hoses 225. In further embodiments, the connector storage unit 270 may have additional storage components for additional connectors other than electrical cables 233 and air hoses 225.

By stowing the electrical cable 233 in the storage socket 236 and the air hoses 225 with the dummy couplers 228 when not attached to a trailer, the electrical cable 233 and air hoses 225 can be protected from damage. For example, the dummy couplers 228 may block out dirt and moisture to the keep the air hoses 225 clean and prevent the air supply from being blocked by debris. Similarly, the storage socket 236 may protect a stowed end of the electrical cable 233 from moisture, and, as described herein, may even substantially eliminate moisture already in the stowed end. Further, as described herein, the storage socket 236 may be configured to help a vehicle ECU determine a connection state of the electrical cable 233 and provide safety alerts based on the connection state of the cable.

In the depicted embodiment, the dummy couplers 228 are gladhand couplers configured to couple with matching gladhand couplers on the air hoses 225. The dummy couplers 228 may include seals 274, such as a rubber O-rings, to maintain air pressure in the air hoses 225 and substantially prevent leakage. The dummy couplers 228 may also include latches 276 to secure the connection between the dummy coupler 228 and the gladhand coupler on the air hose 225. In alternative embodiments, different coupling mechanisms may be used to stow the air hoses 225 with the connector storage unit 270.

The storage socket 236 may be substantially the same shape as an end of the electrical cable 233 to provide a tight fit, substantially preventing moisture from seeping into the storage socket 236 while the electrical cable 233 is stowed. For example, the storage socket 236 may be round to match a round end of the electrical cable 233, with an inner circumference of the storage socket 236 being slightly greater than an outer circumference of the end of the electrical cable 233. In an embodiment, the storage socket 236 is substantially the same shape as an electrical socket on a trailer. The storage socket 236 may include a plurality of electrical contacts, shown as prongs 277, for interacting with plugs in the end of the electrical cable 233. This may allow electricity to flow from the electrical cable 233 to different components in the storage socket 236 and/or the connector storage unit 270. Different embodiments may have different numbers of prongs 277 to match different configurations of electrical cables 233. In alternative embodiments, the storage socket 236 may have no prongs 277, and no electricity flows from the electrical cable 233 to the storage socket 236.

The storage socket 236 may also include a sensing element 278. In such embodiments, the sensing element 278 may be used to determine if an electrical cable 233 is stowed in the storage socket 236. In an embodiment, the sensing element 278 may be a resistive circuit in the storage socket 236 that receives power from the prongs 277, allowing a sensed resistance on the electrical cable 233 to be used to determine the connection state of the cable 233. In alternative embodiments, the sensing element 278 may be a near-field communication (NFC) tag, sonar sensor, or capacitance sensor. In further embodiments, the sensing element 278 may be other types of proximity sensors. In the depicted embodiment, the sensing element 278 is in a base of the storage socket 236 with the prongs 277. In alternative embodiments, the sensing element 278 may be on a wall of the storage socket 236, or in other locations on the storage socket 236 or the connector storage unit 270 where the sensing element 278 can sense the presence of an electrical cable 233 in the storage socket 236.

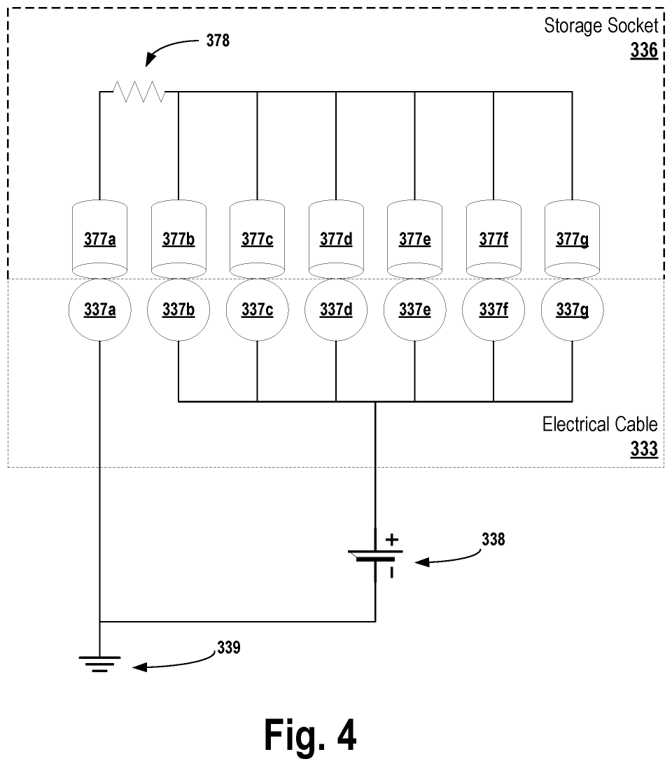

FIG. 4 illustrates an example circuit diagram of a resistive circuit that may act as a sensing element in a storage socket 336. In the illustrated circuit diagram, the storage socket 336 includes seven prongs 377 for interacting with seven plugs 337 in the electrical cable 333 for forming an electrical connection between the cable 333 and the circuit elements in the storage socket 336. In the depicted embodiment, six of the plugs 337b-g in the electrical cable 333 connect to a power source 338 (e.g., as received at an opposite side of the electrical cable from the electrical subsystem 130), and the seventh plug 337a connects to ground 339 (e.g., either at the electrical subsystem 130 and/or by a grounding attachment to a chassis of the tractor 102). In an embodiment, the power source 338 is a direct current power source. In alternative embodiments, the power source 338 is an alternating current power source, and the circuit may include a rectifier. Although the illustrated embodiment shows the storage socket 336 with seven prongs 377 and the electrical cable 333 with seven plugs 337, different numbers of prongs 377 and plugs 337 may be used in alternative embodiment, e.g., there may be six prongs 377 and six plugs 337.

A resistive element 378 may be included between the six powered plugs 377b-g and the ground plug 377a. In the illustrated embodiment, the resistive element 378 is a resistor. As described herein, the resistive element 378, combined with the natural resistance of elements of the storage socket 336 circuit, such as wires, may be a known resistance. The vehicle, e.g., vehicle controller 160, may sense the known resistance by monitoring a resistance across conductors in the electrical cable 333, to determine a connection state of the cable 333. For example, if the resistive element 378 combined with the natural resistance of the storage socket 336 circuit elements is 10062 (one hundred ohms), when a vehicle ECU senses a 10062 load on the electrical cable 333, it may infer that the cable 333 is stowed in the storage socket 336. The sensed load need not be exactly the known resistance of the storage socket 336 circuit elements: the vehicle control unit may infer that the cable 333 is stowed in the storage socket 336 if the sensed load is substantially the same as the known resistance (e.g., within a predetermined threshold, such as +/−10-20%). In alternative embodiments, the resistive circuit may include multiple resistive elements 378 and/or other circuit elements. In further embodiments, the resistive element 378 may be located at a different location within the circuit, or no resistive element 378 may be included at all and instead the natural resistance of other circuit elements is used to create a known resistance within the storage socket 336. In still further embodiments, the resistive element 378 may be electrically connected between fewer than all (but at least one) of the powered plugs 377b-g and the ground plug 377a.

The resistive element 378 may also be used to substantially eliminate moisture in the plugs 337 of the electrical cable 333 when it is stowed in the storage socket 336. As electricity flows through the resistive element 378, heat may be produced. This heat may assist in encouraging evaporation of any moisture at the plugs 337.

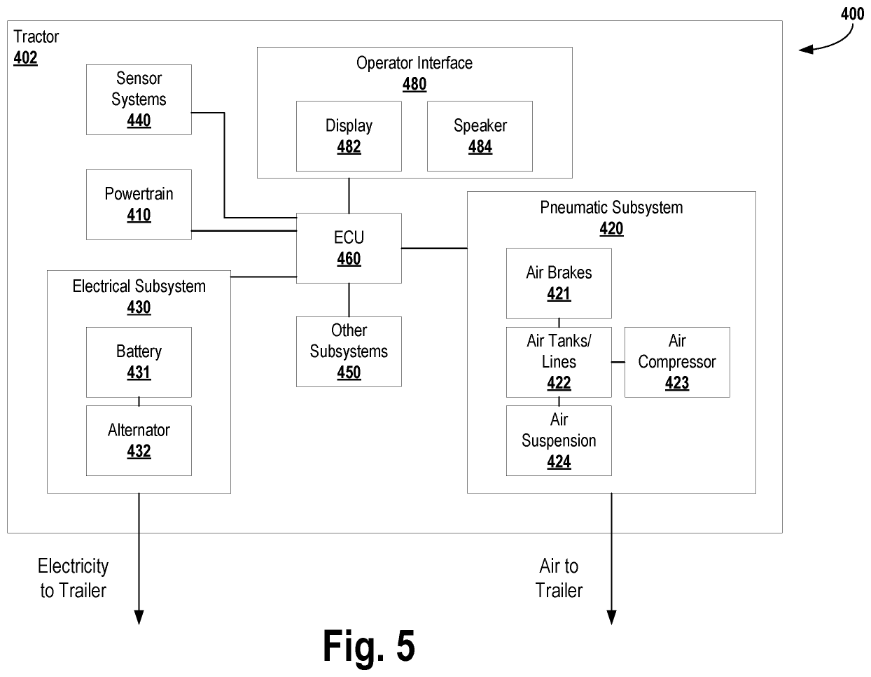

Referring to FIG. 5, a block diagram of an embodiment trailer connection safety system 400 is provided. In the illustrated embodiment, the system 400 includes a vehicle ECU 460, an electrical subsystem 430, a pneumatic subsystem 420, a powertrain 410, sensor systems 440, an operator interface 480, and other vehicle subsystems 450.

The ECU 460 is connected to and communicates with the other systems and subsystems. The ECU 460 therefore may represent a possible implementation of vehicle controller 160 of FIG. 1. The connections from the ECU 460 to other systems within a vehicle may be made by a controller area network bus. As described below, the ECU may use information from these systems to generate safety alerts and loose cable alerts. Although only one ECU is shown in FIG. 5 for ease of illustration, vehicle computer systems may include many ECUs, some of which may be dedicated to controlling specific vehicle systems or subsystems. ECUs can be implemented in a variety of hardware, software, and combination hardware/software configurations, for carrying out aspects of the present disclosure. A typical ECU includes a processor (e.g., a microcontroller), memory, and one or more communication links. The memory may include an electronically erasable, programmable, read-only memory (EEPROM) or other non-volatile memory (e.g., flash memory) and/or random access memory (RAM). The memory may include program instructions in the form of modules, applications, and/or the like that are executable by the processor. In particular, the memory may include program instructions that implement functionality of the system 400.

The electrical subsystem 430) represents a possible implementation of electrical subsystem 130 of FIG. 1, and provides electricity to the tractor 402 and its systems and subsystems, as well as providing electricity to trailers that may be coupled with the tractor 402. Electricity may be provided from the electrical subsystem 430 to a coupled trailer via an electrical cable. The electrical subsystem 430 includes a battery 431 and an alternator 432. The battery 431 provides electricity when an engine of the tractor 402 is not running. When the engine is running, the alternator 432 provides electricity and recharges the battery 431.

In the example shown, the pneumatic subsystem 420 may be used to implement the pneumatic subsystem 120 of vehicle 100 of FIG. 1, and includes air brakes 421, an air compressor 423, an air suspension 424, and air tanks and lines 422. The air brakes 421 use pressurized air from the air tanks 422 to decelerate the tractor 402. The air compressor 423 repressurizes the air tanks 422 when the air pressure in the tanks 422 drops below a threshold. The air suspension 424 utilizes airbags on axles of the tractor 402 to stabilize the tractor 402 as it drives by absorbing bumps and vibrations with the airbags. The air suspension 424 may also be used to raise and lower the tractor 402 as it couples with and decouples from trailers.

In the example shown, the powertrain 410 produces power and converts that power to move the tractor 410. As previously noted, powertrain 410 may include an engine and a transmission. The sensor systems 440 may be used to implement sensor system 140 of FIG. 1, and provide information to the ECU 440, such as speed and height of the tractor 402. In embodiments, sensors of the sensor systems 440 may be part of other subsystems, such as the electrical subsystem 430 or the pneumatic subsystem 420.

The operator interface 480 represents an example of another vehicle subsystem 150 of FIG. 1, and provides information about the tractor 420 and its subsystems to an operator. The operator interface 480 may include a display 482 for displaying visual alerts and other information to the operator. The display 482 may be positioned within a cab of the tractor, e.g., within tractor 102 of FIG. 1. The operator interface 480 may also include a speaker 484 for presenting auditory alerts to the operator. As described below, these alerts may include safety alerts and loose cable alerts.

The system 400 may also include various other vehicle subsystems 450, which correspond to further vehicle subsystems 150 of FIG. 1. For example, the system 400 may include an automatic kingpin release system, allowing a kingpin to be automatically removed from a fifth wheel to decouple a trailer from the tractor 402. Other subsystems that perform different tasks within the tractor 402 may also be included in the system 402, examples of which are provided above.

In examples of the present disclosure, the ECU 460 may monitor a connection state of an electrical cable (e.g., electrical cable 133, 233, 333) through the electrical subsystem 430 and generate safety alerts if it determines that the electrical cable is not in an appropriate state for an action taken by an operator of the tractor 402. As described above, the connection state of cable may be determined by a sensed resistance on the electrical cable. The actions by the operator may involve other systems of the tractor 402. For example, when the operator actuates one or more other vehicle subsystems to supply air from the pneumatic system 420 to a trailer, the ECU 460 may check if the electrical cable is also connected to the trailer. If the ECU 460 determines that the electrical cable is not connected to the trailer, the ECU 460 may generate a safety alert, which it transmits to the operator interface 480, where it may be presented to the operator on the display 482 and/or through the speaker 484. In addition to generating a safety alert, the ECU 460 may be configured to act as an interlock when it determines the that the electrical cable is not in an appropriate state for the action initiated by the operator. For example, if the ECU 460 determines that the electrical cable is not connected to the trailer, but air is being provided to the trailer, the ECU 460 may control the powertrain 410 to prevent the operator from driving until the electrical cable is connected to the trailer. Further, the ECU 460 may provide safety alerts and/or act as an interlock if it determines that the electrical cable is connected to the trailer and air has not been supplied to the trailer.

In another example, the ECU 460 may verify that the electrical cable is properly stowed when the operator decouples the tractor 402 from the trailer. If the ECU 460 determines that the operator is decoupling the tractor 402 from the trailer, if the electrical cable is still connected to the trailer, the ECU 460 may generate a safety alert. The ECU 460 may determine that the electrical cable is still connected to the trailer based on a known resistance sensed at the electrical cable being different from the

The ECU 460 may also act as an interlock to prevent the operator from decoupling the tractor 402 from the trailer if it determines that the cable is still connected to the trailer.

In a third example, the ECU 460 may provide loose cable alerts when the electrical cable is not properly stowed while the tractor 402 is in operation without a trailer coupled to it. If the ECU 460 determines that the cable is not connected to a trailer but is also not stowed in a storage socket, the ECU 460 may generate a loose cable alert to alert the operator that the cable has not been properly stowed.

The ECU 460 may also be configured to assist in the decoupling of the tractor 402 from a trailer based on the connection state of the electrical cable. When the ECU 460 determines that the electrical cable has been stowed in a storage socket on the tractor 402, the ECU 460 may automatically activate a system to release the kingpin. The ECU 460 may additionally, or alternatively, lower the air suspension 424 of the tractor 402. The ECU 460 may perform these actions immediately upon determining that the electrical cable has been stowed in the storage socket, or it may start a timer when the cable is stowed and then perform the actions after the timer has reached zero. Additionally, the ECU 460 may only perform these actions upon determining that the electrical cable has been stowed in the storage socket shortly after being disconnected from a trailer—for example, within a few seconds.

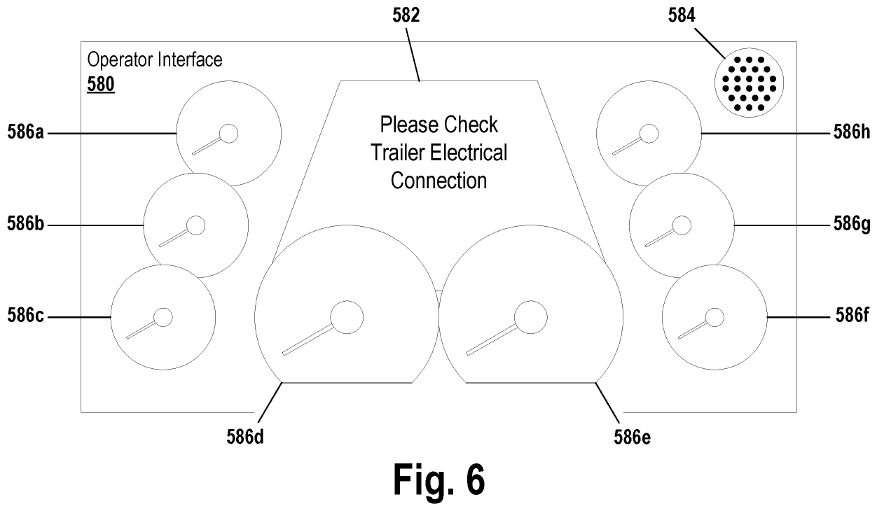

FIG. 6 illustrates an operator interface 580 with a safety alert displayed. The operator interface 580 may be positioned in a tractor, e.g., in a cab, for example on a dashboard. In the illustrated embodiment, the operator interface 580 includes a display 582, a speaker 584, and a plurality of gauges 586. These gauges 586 may monitor different conditions of the tractor, such as speed, revolutions per minute of an engine, and fuel level. In alternative embodiments, the operator interface 580 may include different gauges 586 for monitoring various conditions of the tractor.

The display 582 may be any type of display used in a vehicle to convey information to an operator, such as a light emitting diode display or a liquid crystal display. The display 582 may be configured to display a safety alert received from an ECU. As depicted in FIG. 6, the safety alert may say “Please Check Trailer Electrical Connection.” In alternative embodiments, the safety alert may be worded differently. Additionally, in alternative embodiments, the safety alert may be displayed as a light on an operator dashboard, similar to a check engine light, to alert the operator that the electrical cable is in an inappropriate connection state. The display 582 may similarly be configured to display loose cable alerts.

The speaker 584 may be configured to provide an auditory indicator when the operator interface 584 receives a safety alert or loose cable alert from the ECU. In an embodiment, the auditory indicator may be a repeated beeping sound. In alternative embodiments, the speaker 584 may play a spoken version of the safety alert/loose cable alert that is displayed visually on the display 582. The operator interface of FIG. 6 includes one speaker 584: however, in alternative embodiments, multiple speakers 584 may be used. In further embodiments, the speaker 584 may be located in a different location on the operator interface 580, or it may be included with a different system in the tractor.

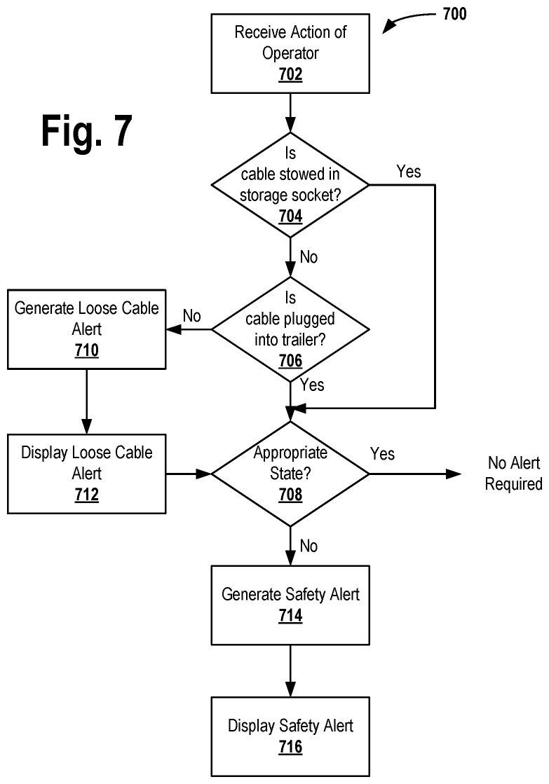

Turning to FIG. 7, a flowchart of a method 700 for generating alerts using the system described above. The method 700 may be performed by various systems of a vehicle for example those shown above in conjunction with FIGS. 1-6, including the vehicle 100 of FIG. 1.

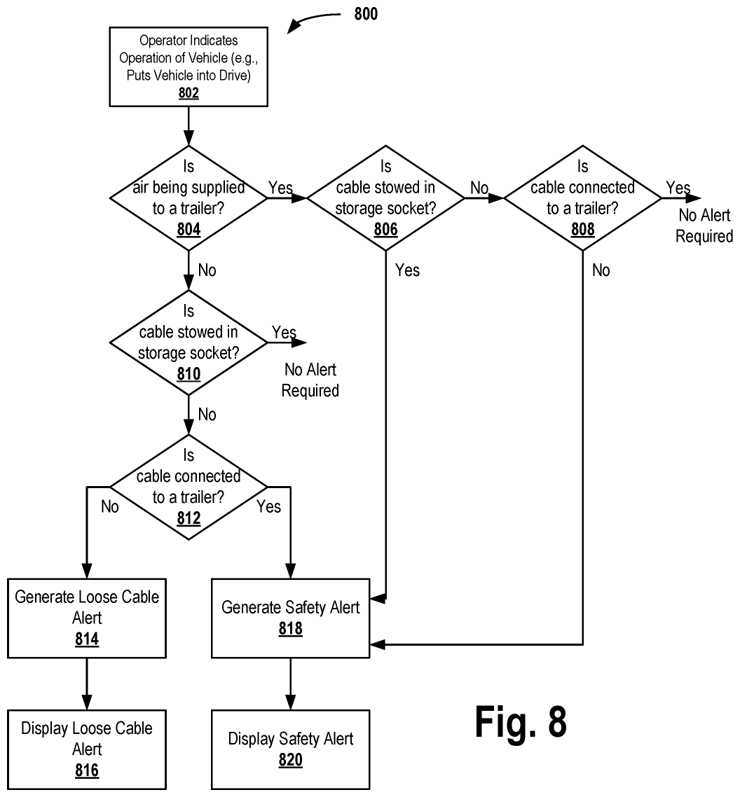

At a first step 702 of the method 500, a vehicle system receives an action of an operator. Examples of actions by an operator include supplying air to a trailer and decoupling a tractor from a trailer. FIGS. 8-10 illustrate example flowcharts of methods for generating alerts for specific operator actions. While specific operator actions are given in these examples, the system is not limited to generating alerts for only these operator actions; operator actions may include any action by an operator of a vehicle.

At steps 704 and 706, the method 700 includes the vehicle system determining a connection state of the electrical cable. For example, at step 704, the vehicle system checks if the electrical cable is stowed in a storage socket. As described above, the vehicle system may use a sensed resistance on the electrical cable to determine if the electrical cable is stowed. In alternative embodiments, different sensing elements may be used to determine if the cable is stowed, such as proximity sensors. If the vehicle system detects that the cable is stowed in the storage socket, the method 700 proceeds to step 708, otherwise it proceeds to step 706. At step 706, the vehicle system checks if the electrical cable is plugged into a trailer. As described above, like with the storage socket, the vehicle system may use a sensed resistance to determine if the electrical cable is plugged into the trailer. If the vehicle system determines that the cable is plugged into a trailer, the method 700 proceeds to step 708, otherwise it proceeds to steps 710 and 712 to generate and display a loose cable alert before proceeding to step 708. As described above, the loose cable alert may be displayed on an operator interface in a tractor.

In embodiments, the storage socket has a known baseline resistance, so if the system senses a resistance that is substantially the same as the baseline resistance, it infers that the cable is stowed, and if the system senses a substantially different resistance, the system infers that the cable is plugged into the trailer. If no resistance is sensed on the cable, or if an open circuit is sensed, the system may infer the cable is loose-neither stowed nor plugged into the trailer.

In alternative embodiments, the system may be configured to generate alerts without performing step 706. If the vehicle system detects at step 704 that the cable is not stowed in the storage socket, it may infer that it is plugged into a trailer and the method 700 may skip step 706. Similarly, in some alternative embodiments, the method 700 may be performed without performing step 704. In those embodiments, if the vehicle system determines that the cable is not plugged into the trailer at step 706, it may infer that the cable is stowed in the storage socket. Alternatively, the method 700 may be performed by first assessing at step 706 whether the cable is plugged into the trailer, and subsequently assess, if the cable is not plugged into the trailer, whether the cable is in fact stowed (at step 704).

At step 708, method 700 includes the vehicle system determining if the electrical cable is in an appropriate state for the action of the operator. If the electrical cable is in an appropriate state given the action of the operator, no action or alert is required. However, if the state of the electrical cable is not appropriate for the action of the operator, an action or alert may be advisable. For example, if air is being supplied to a trailer, but the electrical cable is not plugged into the trailer, the electrical cable is not in an appropriate state. More examples of when the electrical cable is not in an appropriate state are described below in FIGS. 8-10. If the vehicle system determines that the cable is not in an appropriate state, the method 700 proceeds to steps 714 and 716 where a safety alert is generated and displayed. Like the loose cable alert in step 712, the safety alert may be displayed on an operator interface.

In further embodiments, additional steps may be added to use the vehicle system as an interlock to prevent the action of the operator if the cable is not in an appropriate state. The vehicle system may also or alternatively prevent actions other than the action detected in step 702. For example, if the vehicle system detected that air was being supplied to a trailer at step 702 and then determines at step 708 that the electrical cable is not in an appropriate state for that action because the cable is stowed, the vehicle system may prevent an operator from driving, rather than preventing air from being supplied to the trailer. It is understood that the vehicle system may similarly act as an interlock in additional steps not shown in FIGS. 8-10.

If the vehicle system generates a loose cable alert at step 710 and a safety alert at step 714, in some cases, the safety alert may take priority over the loose cable alert. In such embodiments, at step 716, the loose cable alert is no longer displayed and only the safety alert is displayed. In alternative embodiments, the vehicle system may wait to perform steps 710 and/or 712 until it is determined whether a safety alert should be generated at steps 708 and 714. In such embodiments, if a safety alert is generated at step 714, the vehicle system may forgo performing steps 710 and/or 712 and may only display the safety alert at step 716. In still further embodiments, for example where a loose cable alert is icon-based and the safety alert corresponds to a textual message, both alerts may be displayed simultaneously.

FIG. 8 illustrates an example method 800 for generating alerts using a trailer connection safety system. In the example of method 800, such alerts may be generated in an instance when an operator initiates operation of a vehicle, for example to indicate an intent to place the vehicle into motion. In the example shown, at step 802, the operator puts the vehicle into drive, and a vehicle system, such as a control system of the vehicle (e.g., the ECU, as discussed above), detects this action. The vehicle system may detect this action by receiving a signal from a vehicle subsystem indicating that the action is being taken. At step 804, the vehicle system determines whether air is being supplied to a trailer. The vehicle system may also determine whether air has recently been supplied to the trailer. In alternative embodiments, at step 804, the control system may use other indicators other than air to determine whether a tractor is coupled to the trailer. Depending on whether air is being supplied to the trailer or not, the method 800 proceeds to either step 806 or step 810.

At step 810, the vehicle system determines whether an electrical cable is stowed in a storage socket on the tractor. As described above, this may be accomplished by the control system sensing a resistance on the cable, or receiving a signal from a proximity sensor in or around the storage socket. If the vehicle system determines that the cable is stowed, the method 800 may terminate without generating a safety alert. Because the tractor is not coupled to a trailer—as indicated by air not being supplied to a tractor—it is considered, at least for this purpose, safe for the cable to be stowed. If the vehicle system determines that the cable is not stowed, the method 800 proceeds to step 812.

At step 812, the method 800 includes the vehicle system determining whether the cable is connected to the trailer. If the vehicle system determines that the cable is not connected the trailer, the method 800 proceeds to steps 814 and 816 where a loose cable alert is generated and displayed (e.g., where the operator intends to drive the tractor, but neither air nor electricity is supplied to the trailer). If the vehicle system determines that the electrical cable is connected to a trailer, the method 800 proceeds to steps 818 and 820 and a safety alert is generated is displayed (e.g., because the operator intends to drive the tractor, and in this case, air is not supplied but the electrical connector is not connected). This safety alert may be configured to warn the operator to supply air to the trailer. As described above, the alerts may be displayed on an operator interface.

If the vehicle system determines at step 804 that air is not being supplied to the trailer, the method includes the system then determining whether the cable is stowed at step 806. If the vehicle system determines that the cable is stowed, the method 800 proceeds to steps 818 and 820, and a safety alert is generated and displayed. The safety alert may warn the operator to connect his cable to the trailer. If the vehicle system determines that the cable is not stowed, the method 800 proceeds to step 808 and the system determines if the cable is connected to the trailer. If the vehicle system determines that the cable is connected to the trailer, the method 800 ends because both electricity and air are being supplied to the trailer, so it is safe for the operator to drive. If the vehicle system determines that the cable is not connected to the trailer, the method 800 proceeds to steps 818 and 820 and a safety alert is generated and displayed.

In some embodiments, the method 800 may skip steps 806, 808, 810, and/or 812. For example, if the vehicle system determines that cable is not stowed at step 806, it may infer that the cable is connected to a trailer and proceed to steps 818 and 820 to generate and display a safety alert. Similarly, the method 800 may be executed by excluding step 812 and inferring that the cable is connected to the trailer if it is not determined to be stowed at step 810. Additionally, the method 800 may be executed by excluding step 806 and proceeding directly to step 808 to determine if the cable is connected to a trailer after determining that air is being supplied to a trailer at step 804. This may be done because regardless of whether the cable is stowed or loose, a safety alert should be generated if air is being supplied to the trailer. Further, the method 800 may be performed by excluding step 810) and proceeding directly to step 812, inferring that the cable is stowed if it determines that the cable is not connected to the trailer at step 812.

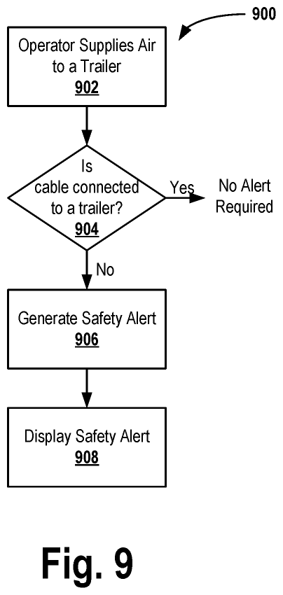

FIG. 9 illustrates an example method 900 for generating safety alerts when an operator supplies air to a trailer using a trailer connection safety system. As above, the method 900 may be performed, at least in part, using a vehicle system such as a control system of a vehicle (e.g., an ECU) as previously described.

At a first step 902, the method 900 includes receiving an indication that an operator is supplying air to a trailer, for example at the vehicle system. Next, at step 904, the method 900 further includes the control system determining if an electrical cable is connected from a tractor to the trailer. This may be done by sensing a resistance on the cable. In alternative embodiments, this may be done by determining if the cable is stowed in a storage socket on the tractor, and if it is not, the system may infer that the cable is connected to the trailer.

If the vehicle system determines that the cable is connected to the trailer, the method 900 ends: both air and electricity are being supplied to the trailer, so it is safe for the operator to drive, and no alert is required. If the vehicle system determines that the cable is not connected to the trailer, the method 900 proceeds to steps 906 and 908, where a safety alert is generated and displayed. Such a safety alert may be displayed using an operator interface as described above in conjunction with FIG. 6.

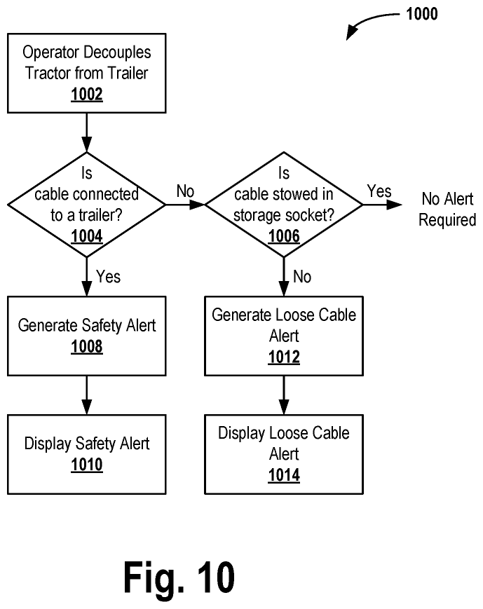

FIG. 10 illustrates an example method 1000 for generating safety alerts when an operator decouples a tractor from a trailer using a trailer connection safety system. At step 1002, the method 1000 includes the vehicle system receiving an indication that the operator is decoupling the tractor from the trailer. In an embodiment, the vehicle system may receive a signal that the operator is lowering an air suspension of the tractor, from which the vehicle system may infer that the tractor is being decoupled from the trailer. In an alternative embodiment, the vehicle system may receive a signal that a kingpin has been released, which may be from a subsystem in the tractor configured to automatically release the kingpin for the operator. In further embodiments, other indications may be used by the system to determine that the operator is decoupling the tractor from the trailer.

At step 1004, the method 1000 includes the vehicle system determining whether an electrical cable is connected to the trailer. As previously discussed, this may be done by sensing a resistance on the cable. If the vehicle system determines that the cable is still connected to the trailer, the method 1000 proceeds to steps 1008 and 1010 where a safety alert is generated and displayed. The safety alert may inform the operator that his electrical cable is still connected and ask him to stow the cable. If the vehicle system determines that the cable is not connected to a trailer, the method 1000 proceeds to step 1006 to determine if the cable is stowed in a storage socket on the tractor. As with step 1004, this may be performed by sensing a resistance on the cable, with the storage socket having a known resistance. If the vehicle system determines that the cable is stowed in the storage socket, the method 1000 ends: the cable is properly stowed, so it is safe for the operator to decouple from the trailer. If the vehicle system determines that the cable is not stowed in the storage socket, the method 1000 proceeds to steps 1012 and 1014 where a loose cable alert is generated and displayed.

In alternative embodiments, the vehicle system may only check if the cable is connected to the trailer in step 1004 and the method 1000 may therefore exclude step 1006 to determine if the cable is stowed. In this embodiment, a safety alert is generated and displayed if the cable is still connected to the trailer at step 1004, but if the cable is not still connected, the method 1000 ends. Alternatively, in other alternative embodiments, the vehicle system may only check if the cable is stowed in the storage socket, skipping step 1004. In this embodiment, the method 1000 ends if the cable is stowed, otherwise a safety alert is generated and displayed. In further embodiments, the steps of the method 1000 described in FIG. 10 may be performed in a different order, such as checking if the cable is stowed before checking if the cable is connected to the trailer, and the system may take different actions depending on the determined connection state of the cable.

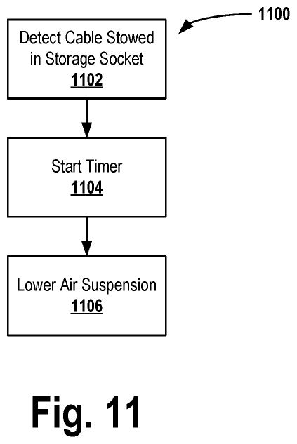

Turning to FIG. 11, a method 1100 for assisting in decoupling a tractor from a trailer based on a connection state of an electrical cable is shown. The method 1100 may include, for example, assistance by a vehicle system in a decoupling process. At a first step 1102, the method 1100 includes detecting that the electrical cable is stowed in a storage socket on the tractor. Detecting the electrical cable stowed in the storage socket may include, for example, analyzing a signal received at an ECU of the tractor, such as from a sensing element 278 as described above.

In response to detecting stowing of the electrical cable, the method 1100 may include, at step 1102, setting a timer at the vehicle system, such as in an ECU of the tractor. In alternative embodiments, the timer may be set on a different component of the tractor. In some embodiments, the method 1100 will not proceed to step 1104 every time the electrical cable is stowed: in addition to the cable being stowed, it may also be required that the electrical cable was connected to the trailer before being stowed. In other alternative embodiments, the operator may need to indicate to the ECU that he or she is beginning a decoupling process for the storage for the electrical cable to initiate the method 1100. By adding these additional requirements, the likelihood that the system inappropriately takes a decoupling action is reduced.

After the timer reaches a threshold, the method 1100 proceeds to step 1106, where the vehicle system initiates an action to assist in the decoupling of the tractor from the trailer. In one example embodiment, the ECU controls an air suspension system in the tractor to lower the air suspension, thereby increasing the clearance between the tractor and the trailer at a coupling mechanism of the tractor. In alternative embodiments, the ECU may activate a system that automatically releases a kingpin in the coupling mechanism. In further embodiments, other actions may be taken to expedite the decoupling process for an operator. By automatically performing these actions when the cable is stowed in the storage socket, the decoupling process is easier for the operator, and the number of times in which the operator must get in and out of the cab of the tractor during the decoupling process may be reduced.

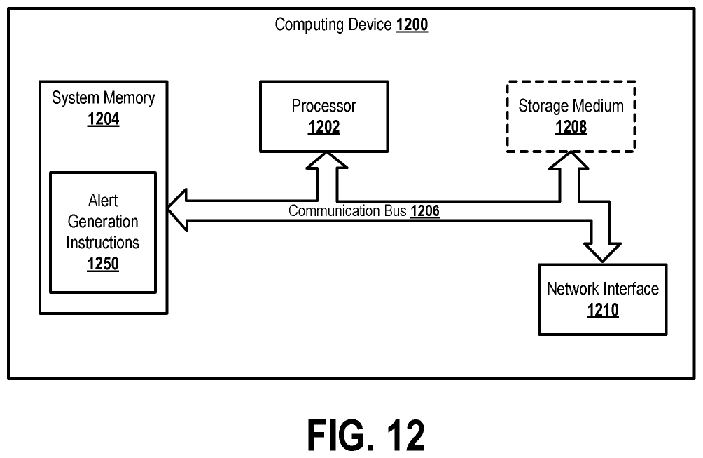

Referring now to FIG. 12, a block diagram of an illustrative computing device 1200 appropriate for use in accordance with embodiments of the present disclosure is shown. The description below is applicable to the ECU 460 or other vehicle control systems, as well as various servers, personal computers, mobile phones, smart phones, tablet computers, embedded computing devices, and other currently available or yet-to-be-developed devices that may be used in accordance with embodiments of the present disclosure.

In its most basic configuration, the computing device 1200 includes at least one processor 1202 and a system memory 1204 connected by a communication bus 1206. Depending on the exact configuration and type of device, the system memory 1204 may be volatile or nonvolatile memory, such as read-only memory (“ROM”), random access memory (“RAM”), EEPROM, flash memory, or other memory technology. Those of ordinary skill in the art and others will recognize that system memory 1204 typically stores data or program modules that are immediately accessible to or currently being operated on by the processor 1202. In this regard, the processor 1202 may serve as a computational center of the computing device 1200 by supporting the execution of instructions. According to one example, the system memory 1204 may store one or more instructions 1250 for generating alerts as described above.

As further illustrated in FIG. 12, the computing device 1200 may include a network interface 1210 comprising one or more components for communicating with other devices over a network. Embodiments of the present disclosure may access basic services that utilize the network interface 1210 to perform communications using common network protocols. The network interface 1210 may also include a wireless network interface configured to communicate via one or more wireless communication protocols, such as WiFi, 2G, 3G, 4G, 5G, LTE, WiMAX, Bluetooth, or the like.

In the illustrative embodiment depicted in FIG. 12, the computing device 1200 also includes a storage medium 1208. However, services may be accessed using a computing device that does not include means for persisting data to a local storage medium. Therefore, the storage medium 1208 depicted in FIG. 12 is optional. In any event, the storage medium 1208 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, or the like.

As used herein, the term “computer-readable medium” includes volatile and nonvolatile and removable and non-removable media implemented in any method or technology capable of storing information, such as computer-readable instructions, data structures, program modules, or other data. In this regard, the system memory 1204 and storage medium 1208 depicted in FIG. 12 are examples of computer-readable media.

For ease of illustration and because it is not important for an understanding of the claimed subject matter, FIG. 12 does not show some of the typical components of many computing devices. In this regard, the computing device 1200 may include input devices, such as a keyboard, keypad, mouse, trackball, microphone, video camera, touchpad, touchscreen, electronic pen, stylus, or the like. Such input devices may be coupled to the computing device 1200 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 1200 (e.g., a client device), or can be integral components of the computing device 1200. In some embodiments, multiple input devices may be combined into a single, multifunction input device (e.g., a video camera with an integrated microphone). The computing device 1200 may also include output devices such as a display, speakers, printer, etc. The output devices may include video output devices such as a display or touchscreen. The output devices also may include audio output devices such as external speakers or earphones. The output devices can be separate from and communicatively coupled to the computing device 1200, or can be integral components of the computing device 1200. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl. HTML, CSS, Javascript, VBScript, ASPX, Microsoft .NET™ languages such as C#, or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method comprising:
receiving, at an electronic control unit of a vehicle, a signal indicating an action by an operator of a vehicle, the electronic control unit being communicatively connected to a vehicle control subsystem;
determining a connection state of an electrical cable, the electrical cable having a first end electrically connected to the vehicle control subsystem and a second end removably connectable to an electrical socket of a trailer, wherein when the second end is connected to the electrical socket of the trailer, an electrical connection is formed between the vehicle control subsystem and the trailer;
determining whether the connection state of the electrical cable is an appropriate state for the action by the operator;
based on a determination that the connection state of the electrical cable is not an appropriate state for the action by the operator, generating an alert indicating that the electrical cable is in not in an appropriate state for the action by the operator; and
presenting the alert at an operator interface.

2. The method of claim 1, wherein determining the connection state of the electrical cable includes detecting whether the second end of the electrical cable is stowed at a storage socket on a tractor.

3. The method of claim 2, wherein the storage socket is configured to use heat produced by a resistive element to substantially eliminate moisture in the second end of the electrical cable when the second end of the electrical cable is stowed at the storage socket.

4. The method of claim 1, wherein determining the connection state of the electrical cable includes sensing a resistance on the electrical cable.

5. The method of claim 1, wherein the connection state of the electrical cable is not an appropriate state if the second end of the electrical cable is not connected to the trailer and the action of the operator involves supplying air to the trailer.

6. The method of claim 1, wherein the connection state of the electrical cable is not an appropriate state if the second end of the electrical cable is connected to the trailer and the action of the operator is indicative of the decoupling the trailer.

7. The method of claim 1, wherein the connection state of the electrical cable is not an appropriate state if the second end of the electrical cable is connected to the trailer and the action of the operator involves driving the vehicle without supplying air to the trailer.

8. The method of claim 1, wherein the connection state of the electrical cable is not an appropriate state if the second end of the electrical cable is neither stowed at a storage socket on the tractor nor connected to the trailer and the action of the operator is indicative of the operator driving the vehicle.

9. The method of claim 1, further comprising:
based on a determination that that the connection state of the electrical cable is not an appropriate state for the action by the operator, preventing the action by the operator.

10. The method of claim 1, further comprising:
based on a determination that the connection state of the electrical cable is not an appropriate state for the action by the operator, preventing the operator from driving the vehicle.

11. A method comprising:
receiving, at an electronic control unit of a vehicle, a signal indicating an action by an operator of a vehicle, the electronic control unit being communicatively connected to a vehicle control subsystem, the action being an action indicating intended operation of the vehicle;
determining a connection state of an electrical cable, the electrical cable having a first end electrically connected to the vehicle control subsystem and a second end removably connectable to an electrical socket of a trailer, wherein determining the connection state includes:
detecting whether the second end of the electrical cable is stowed at a storage socket on a tractor;
detecting whether the second end of the electrical cable is connected to the electrical socket of the trailer, thereby forming an electrical connection between the vehicle control subsystem and the trailer:
determining whether the connection state of the electrical cable is an appropriate state for the action by the operator;
based on a determination that the connection state the electrical cable in not an appropriate state for the action by the operator, generating an alert indicating that the electrical cable is in not in an appropriate state for the action by the operator; and
presenting the alert at an operator interface.

12. The method of claim 11, wherein detecting whether the second end of the electrical cable is stowed at the storage socket on the tractor includes:
determining if a sensed resistance on the electrical cable is substantially the same as a known resistance of a resistive circuit in the storage socket.

13. The method of claim 11, wherein detecting whether the second end of the electrical cable is connected to the electrical socket of the trailer includes:
determining if a sensed resistance on the electrical cable is substantially different from a known resistance of a resistive circuit in the storage socket.

14. The method of claim 11, further comprising:
based on a determination that that the connection state of the electrical cable is not an appropriate state for the action by the operator, preventing the action by the operator.

15. The method of claim 11, further comprising:
based on a determination that the connection state of the electrical cable is not an appropriate state for the action by the operator, preventing the operator from driving the vehicle.

16. A vehicle, comprising:
an electronic control unit communicatively connected to a vehicle control subsystem, the electronic control unit configured to:
receive a signal indicating an action by an operator of a vehicle;
determine a connection state of an electrical cable, the electrical cable having a first end electrically connected to the vehicle control subsystem and a second end removably connectable to an electrical socket of a trailer, wherein when the second end is connected to the electrical socket of the trailer, an electrical connection is formed between the vehicle control subsystem and the trailer;
determine whether the connection state of the electrical cable is an appropriate state for the action by the operator;
based on a determination that the connection state the electrical cable in not an appropriate state for the action by the operator, generate an alert indicating that the electrical cable is in not in an appropriate state for the action by the operator; and
present the alert at an operator interface.

17. The vehicle of claim 16, further comprising:
a storage socket for stowing the second end of the electrical cable when the second end of the electrical cable is not connected to the electrical socket of the trailer.

18. The vehicle of claim 17, wherein the storage socket is configured to substantially eliminate moisture in the second end of the electrical cable when the second end of the electrical cable is stowed in the storage socket.

19. The vehicle of claim 16, wherein the electronic control unit is further configured to:
based on a determination that that the connection state of the electrical cable is not an appropriate state for the action by the operator, prevent the action by the operator.

20. The vehicle of claim 16, wherein the electronic control unit is further configured to:
based on a determination that the connection state of the electrical cable is not an appropriate state for the action by the operator, preventing the operator from driving the vehicle.
